(19) United States
(12) Patent Application Publication
(10) Pub. No.: US 2024/0278425 A1
(43) Pub. Date: Aug. 22, 2024

(54) CONTAINERIZED PLUG-IN SYSTEM FOR ROBOTICS

(71) Applicant: KINOVA INC., Boisbriand (CA)

(72) Inventors: Mathieux BERGERON, Saint-Joseph-du-Lac (CA); Alexandre VANNOBEL, Montreal (CA)

(21) Appl. No.: 18/561,139

(22) PCT Filed: Jun. 29, 2022
(86) PCT No.: PCT/CA2022/051034

§ 371 Date: Nov. 15, 2023

Related U.S. Application Data
(60) Provisional application No. 63/216,115, filed on Jun. 29, 2021.

(51) Int. Cl. B25J 9/16; B25J 9/06

(52) U.S. Cl. CPC B25J 9/1661; B25J 9/06

(57) ABSTRACT

A system comprising: a processing unit; and a non-transitory computer-readable memory communicatively coupled to the processing unit and comprising computer-readable program instructions executable by the processing unit for: operating movements of a robot arm with an operating system using native functions of the robot arm; executing a program from at least one container; receiving commands from the at least one container; and performing at least a function with the robot arm with the operating system using the commands from the at least one container.

### CROSS-REFERENCE TO RELATED APPLICATION

The present application claims the benefit of U.S. Patent Application No. 63/216,115, filed on Jun. 29, 2021 and incorporated herein by reference.

### TECHNICAL FIELD

The present application relates to robotic arms and to operating systems and methods associated with the operation of robotic arms.

### BACKGROUND OF THE ART

Robotic arms are increasingly used in a number of different applications, from manufacturing, to servicing, and assistive robotics, among numerous possibilities. Such robots are usually closed systems that may not allow the inclusion of features to be embedded into the platform by third parties. For example, extended features that may not be included in closed systems of robots may include the integration of end effector tools, the integration of specialised algorithms for control or path planning, the integration of advanced vision systems or AI based features to augment the robot functionality, among other features. To be supported by a robotic solution, it may be required that these features be developed outside of the robot platform. Communication must be programmed between the robot platform and the third-party system to enable the interaction between both systems, leading to unnecessary complexity and management. As an example, a third party wanting to develop a software application may also need to create industrial hardware, wiring, additional integration, etc.

### SUMMARY

It is an aim of the present disclosure to provide a containerized plug-in system for robotics.

Therefore, in accordance with a first aspect of the present disclosure, there is provided a system comprising: a processing unit; and a non-transitory computer-readable memory communicatively coupled to the processing unit and comprising computer-readable program instructions executable by the processing unit for: operating movements of a robot arm with an operating system using native functions of the robot arm; executing a program from at least one container; receiving commands from the at least one container; and performing at least a function with the robot arm with the operating system using the commands from the at least one container.

Further in accordance with the first aspect, for example, the computer-readable program instructions are executable for operating movements of the robot arm in six degrees of freedom of movement.

Still further in accordance with the first aspect, for example, the computer-readable program instructions are executable for receiving and storing the at least one container.

Still further in accordance with the first aspect, for example, the computer-readable program instructions are executable for receiving and storing the at least one container as a third-party container.

Still further in accordance with the first aspect, for example, the computer-readable program instructions are executable for executing the program from a plurality of at least one container concurrently.

Still further in accordance with the first aspect, for example, the computer-readable program instructions are executable for controlling the execution of the programs of the plurality of containers as a function of performance capacity of the operating system.

Still further in accordance with the first aspect, for example, the computer-readable program instructions are executable for receiving the commands from the at least one container as associated with a tool and/or a peripheral.

Still further in accordance with the first aspect, for example, the computer-readable program instructions are executable for performing at least the function with the robot arm and with the tool and/or peripheral.

Still further in accordance with the first aspect, for example, the computer-readable program instructions are executable for performing at least the function with the robot arm and with the tool and/or peripheral, the function including a combination of the native functions and at least one function of the tool and/or peripheral.

Still further in accordance with the first aspect, for example, the tool and/or peripheral is(are) provided.

Still further in accordance with the first aspect, for example, the tool and/or peripheral is configured to be mounted to the robot arm.

Still further in accordance with the first aspect, for example, the computer-readable program instructions are executable for receiving commands from the at least one container, the commands being received from cloud computing and/or an artificial intelligence network.

Still further in accordance with the first aspect, for example, the computer-readable program instructions are executable for performing at least a function with the robot arm with the operating system using the commands from the at least one container while limiting the function to native function capability of the robot arm.

Still further in accordance with the first aspect, for example, the robot arm may be part of the system.

Still further in accordance with the first aspect, for example, the robot arm is a six degree-of-freedom robot arm.

In accordance with a second aspect of the present disclosure, there is provided a robot system comprising: a robot arm; a robot controller system including a processing unit; and a non-transitory computer-readable memory communicatively coupled to the processing unit and comprising computer-readable program instructions executable by the processing unit for operating: an operating system performing native functions of the robot arm, and a container environment for at least one container, wherein the at least one container is executable to send commands from the at least one container, and wherein the robot arm performs at least a function using the commands from the at least one container.

Further in accordance with the second aspect, for example, the robot arm is a serial mechanism having a working end displaceable in at least six degrees of freedom of movement.

Still further in accordance with the second aspect, for example, the at least one container is a third-party container.

Still further in accordance with the second aspect, for example, the computer-readable program instructions are executable for executing the program from a plurality of at least one container concurrently.

Still further in accordance with the second aspect, for example, the computer-readable program instructions are executable for controlling the execution of the programs of the plurality of containers as a function of performance capacity of the operating system.

Still further in accordance with the second aspect, for example, the computer-readable program instructions are executable for receiving the commands from the at least one container as associated with a tool and/or a peripheral.

Still further in accordance with the second aspect, for example, the computer-readable program instructions are executable for performing at least the function with the robot arm and with the tool and/or peripheral.

Still further in accordance with the second aspect, for example, the computer-readable program instructions are executable for performing at least the function with the robot arm and with the tool and/or peripheral, the function including a combination of the native functions and at least one function of the tool and/or peripheral.

Still further in accordance with the second aspect, for example, the tool and/or peripheral may be part of the system.

Still further in accordance with the second aspect, for example, the tool and/or peripheral is mounted to the working end of the robot arm.

Still further in accordance with the second aspect, for example, the computer-readable program instructions are executable for receiving commands from the at least one container, the commands being received from cloud computing and/or an artificial intelligence network.

Still further in accordance with the second aspect, for example, the computer-readable program instructions are executable for performing at least a function with the robot arm with the operating system using the commands from the at least one container while limiting the function to native function capability of the robot arm.

In accordance with a third aspect of the present disclosure, there is provided a robot control system comprising: a processing unit; and a non-transitory computer-readable memory communicatively coupled to the processing unit and comprising computer-readable program instructions executable by the processing unit for operating: an operating system controlling movements of a robot arm; native functions of the robot arm; and at least one container commanding additional functions of the robot arm via a container-specific operating system.

### DESCRIPTION OF THE DRAWINGS

FIG. 1 is a perspective view of an exemplary articulated robotic arm used with the control system of the present disclosure;

FIG. 2 is a perspective view of a working end of the exemplary articulated robotic arm of FIG. 1; and

FIG. 3 is a block diagram of a robot control system in accordance with the present disclosure.

### DETAILED DESCRIPTION

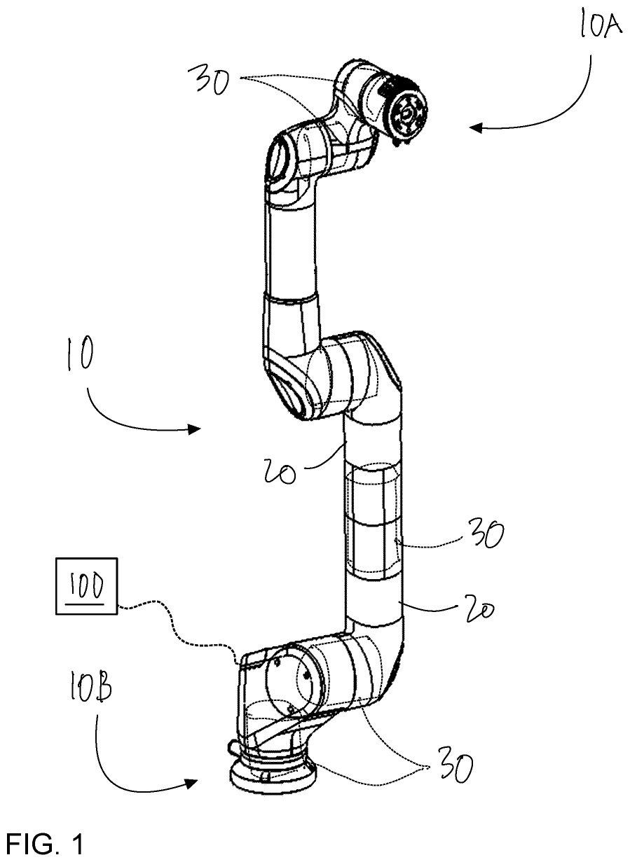

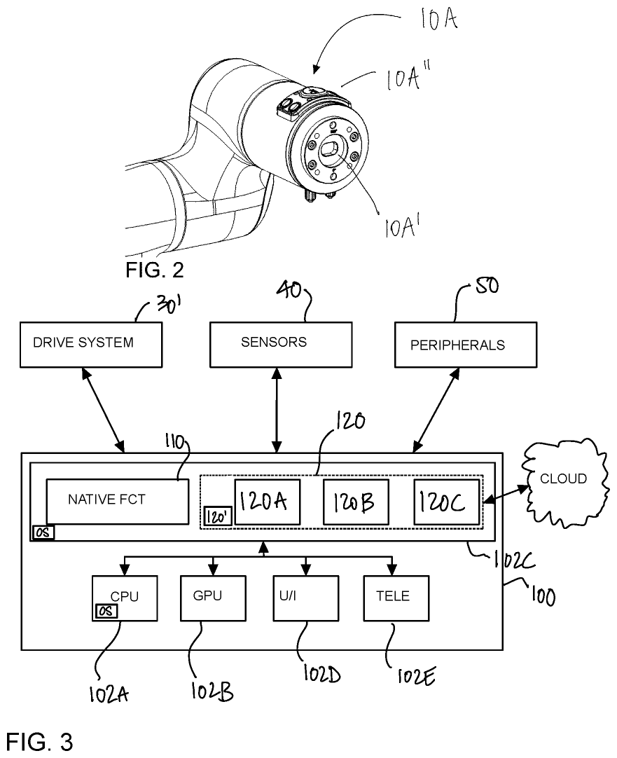

Referring to the drawings and more particularly to FIG. 1, a mechanism such as robot arm in accordance with the present disclosure is generally shown at 10, and is also referred to as an articulated robotic arm or robotic arm, etc. Although a robot control system described herein is shown on the robot arm 10, it may be used with other mechanisms, such as articulated mechanisms or arms, serial mechanisms or arms, parallel mechanisms or arms, or like mechanisms or arms. However, for simplicity, the expression “robot arm” is used throughout, but in a non-limiting manner. The robot arm 10 is a serial articulated robot arm, having a working end 10A, i.e., the end at which an end effector is connected, and a base end 10B. The working end 10A is configured to receive any appropriate tool or tools, such as gripping mechanism or gripper, anthropomorphic hand, tooling heads such as screwdrivers, drills, saws, an instrument drive mechanism, camera, etc. In a variant, the working end 10A may have multiple tools, such as a camera and a gripper, as one possible combination among others. The end effector secured to the working end 10A is as a function of the contemplated use. Referring to FIG. 2, a plug 10A′ and an interface 10A″ may also be present, and may include buttons, an additional port, etc. The working end 10A of FIG. 2 is configured to receive one or more tools thereon via the plug 10A′, with various connectors being shown.

The base end 10B is configured to be connected to any appropriate structure or mechanism. The base end 10B may be rotatably mounted or not to the structure or mechanism. By way of a non-exhaustive example, the base end 10B may be mounted to a wheelchair, to a vehicle, to a frame, to a cart, to a robot docking station. Although a serial robot arm is shown, the joint arrangement of the robot arm 10 may be found in other types of robots, including parallel manipulators.

The robot arm 10 has a series of links 20, interconnected by motorized joint units 30, at the junction between adjacent links 20. A bottom one of the links 20 is shown and referred to herein as a robot arm base link 20′, or simply base link 20′, and may or may not be releasably connected to a docking cradle. A few motorized joint units 30 are shown in FIG. 1 to simplify the illustration, but numerous other motorized joint units 30 may be present. In a variant, the robot arm 10 is a 6 degree of freedom (DOF) arm, in that the working end 10A may be moved in six DOFs relative to the base end 10B, such as translations along X, Y, Z and rotations about phi, theta, ro. Fewer or more DOFs may be present.

The links 20 define the majority of the outer surface of the robot arm 10. The links 20 also have a structural function in that they form the skeleton of the robot arm 10 (i.e., an outer shell skeleton), by supporting the motorized joint units 30 and tools at the working end 10A, with loads supported by the tools, in addition to supporting the weight of the robot arm 10 itself. Electronic components may be concealed into the links 20.

The motorized joint units 30 interconnect adjacent links 20, in such a way that a rotational degree of actuation is provided between adjacent links 20. According to an embodiment, the motorized joint units 30 may also connect a link to a tool at the working end 10A, although other mechanisms may be used at the working end 10A and at the base end 10B. The motorized joint units 30 may also form part of structure of the robot arm 10, as they interconnect adjacent links 20. The motorized joint units 30 form a drive system 30′ (FIG. 3) of the robot arm 10 as they are tasked with driving the end effector connected to the robot arm 10, for instance in accordance with a robotic application or commands, or through user commands. While they are schematically shown, the motorized joint units 30 may include motors, gearboxes, brake(s), drive electronics, among other things, to actuate movements of the robotic arm 10.

A communications link may extend through the robot arm 10. In an embodiment, each link 20 includes signal transmission means (e.g., wires, cables, PCB, plugs and sockets, slip rings, etc), with the signal transmission means being serially connected from the base end 10B to the working end 10A, such that an end effector and a base controller may be communicatively coupled. The communications link may also be via a wireless communications link.

Numerous sensors 40 (FIG. 3) may be provided in the robot arm 10, to automate a control of the robot arm 10. The sensors 40 may include one or more of encoders, optical sensors, inertial sensors, force/torque sensors, infrared sensors, thermocouples, pressure sensors, proximity switches, etc. Moreover, additional peripheral(s) 50 may be mounted to the robot arm 10. In an embodiment, the peripheral 50 may be associated with third party applications, as described below, and may use the available plug 10A′, for instance to be connected to the working end 10A of the robot arm 10 if desired. Exemplary peripherals are a camera(s), a sensor(s), a light source(s). The peripheral(s) 50 may be the end effector as a standalone device, or may be used as a complement to the end effector, or may be part of a group of tools/instruments forming the end effector at the working end 10A of the robot arm 10.

Referring to FIG. 3, a robot control system in accordance with the present disclosure is generally shown at 100. The robot control system 100 may be integrated into the robot arm 10, such as in the base link 20′, in a docking station, in any other link, or as a separate unit, for instance in its casing, in a teach pendant. An assembly of the robot arm 10 and the robot control system 100 may be referred to as robot system. The robot control system 100 may include a processing unit. The processing unit may include all necessary components to operate the robot arm 10, such as a central processing unit (CPU) 102A, graphics processing unit (GPU) 102B, a non-transitory computer-readable memory 102C, that may contain computer-readable program instructions executable by the processing unit for performing given functions associated with the robot arm 10. The CPU 102A may include an operating system OS of the robot arm 10, with or without using the non-transitory computer-readable memory 102C, though the operating system OS may be elsewhere, such as in the memory 102C. An interface or interfaces 102D may be part of the robot control system 100, or may be a peripheral of the robot control system 100, for a user to communicate with and receive data from the robot control system 100. The interface(s) 102D may be embedded or integrated in the robot arm 10, or may be physically separated from the robot arm 10. The interface(s) 102D may take numerous forms, such as a screen or monitor, a graphic user interface (GUI), a touch screen, visual indicators (e.g., LED), tablet, teach pendant, an application on a smart device (e.g., phone, tablet), keyboard, mouse, push buttons, etc. The robot control system 100 may further include telecommunications module 102E by which the robot control system 100 may communication with external devices, systems. The telecommunications module 102E may have wireless and/or wired capability.

For example, the computer-readable program instructions may include native functions 110 of the robot arm 10. The native functions 110 may include one or more of controllably moving the working end 10A in the available degrees of freedom of the robot arm 10; holding a fixed position; performing a safety braking maneuver; permitting hand guiding and teaching; measuring the interaction forces on the robot arm 10, among other native functions. The native functions 110 may be connected to the drive system 30′ for the control system 100 to drive the robot arm 10 in a desired manner. The native functions 110 may also operate based on feedback provided by the sensors 40 within or associated to the robot arm 10. The sensors 40 contribute to the high precision control of the robot arm 10 in its working envelope. The native functions 110 may be driven by the operating system of the CPU 102A, with a user of the robot arm 10 having access to these native functions 110 when operating the robot arm 10 without containers.

Still referring to FIG. 3, the robot control system 100 may further include a container environment 120, for instance as hosted by the non-transitory computer-readable memory 102C, in the form of a virtual environment. The container environment 120 of the robot control system 100 may include a container engine 120′ (though it may be elsewhere, such as in the operating system OS). The container environment 120 may further include a control group, that may also be elsewhere, such as in the operating system OS. The container environment 120 is configured to receive one or more containers, exemplified as containers 120A, 120B, 120C, etc. The containers 120A-C may be programmed, uploaded, and/or transferred into container environment 120, by which applications related to the containers 120A-C may be run with the operating system OS of the robot control system 100—a shared OS—, and have access to the various resources of the robot control system 100, such as CPU 102A, GPU 102B, interface(s) 102D, telecommunications module 102E, sensor data, native functions 110, an application programming interface (API). Any one of the containers 120A-C may include its own dependencies, its entire run-time environment, with code, system tools, libraries, binaries and/or settings, and may be described as including an application or program, performing one or more functions, with the functions associated or not with an operation of the robot arm 10. Because of the container environment 120, the containers 120A-C may therefore be executed by the robot control system 100, in spite of their programming language. The containers 120A-C may be third-party customized, in third party libraries (e.g., Linux). Images of the containers 120A-C, once installed, therefore produce signals that are used by the robot control system 100 to operate the robot arm 10 and/or peripherals. The containers 120A-C may also receive data from the robot control system 100 that may be indicative of the operation or state of the robot arm 10, as obtained by the sensor(s) 40. The control group may be present to ensure that the containers 120A-C have a controlled access to the various resources of the robot control system 100. The control group may be part of the container engine 120′, for example.

In an embodiment, the container environment 120 is of plug-in nature, as it may not alter the operating system of the robot control system 100, and may not alter the native functions 110 (including safety functions), but instead may collaborate with the native functions 110 to have the robot arm 10 perform desired tasks, associated with the containers 120A-C, by way of the runtime of the containers 120A-C. The containers 120A-C may also be said to be isolated, as they may be executed without interfering with one another, or independently from one another. In an embodiment, the containers 120A-C employ the hardware of the robot arm 10, such as the sensors 40 and peripherals 50. It is contemplated to have containers 120A-C usable with peripherals that may be releasably connected to the robot arm 10, at the end effector for example or wired/connected to the robot control system 100 (e.g., as integrated into the robot arm 10 or as a separate component with its own housing).

Consequently, the container environment 120 may allow third parties to add functionality to the robot arm 10 via the access to the robot control system 100. The container environment 120 may not compromise performances of the robot arm 10 and safety features integrated to the operating system of the robot control system 100—the container environment 120 operating within performance capacity of the robot control system 100. The container environment 120 is a manager/host that may be tasked with dynamically limiting the performance of the plugin containers 120A-C in an optimized way, and may act as a firewall to separate the main, priority threads of the operating system from the functions of the containers 120A-C. The installation of a third-party plugin container(s) 120A-C may be assisted by installation widget or icon for a GUI of the interfaces 102D. For example, an installation procedure associated with containers 120A-C may include parameter set-ups for the functionalities of the containers 120A-C, and safety settings. The containers 120A-C may each include a container-specific GUI icon that may allow user activation of the application or functionality related to the container(s) 120A-C, as well as container-specific settings. It may be possible to adjust settings via a settings GUI that is part of the operating system of the robot control system 100. The container-specific GUI icon may integrate into the GUI environment of the interface 102D as operated by the robot control system 100. The plugin containers 120A-C may then have their own GUIs, once an application is activated or once a GUI icon is selected by a user. The plugin containers 120A-C may be written in a language that keeps the interface style the same as the main application/UI. In an embodiment, the settings and safeties associated with any of the containers 120A-C does not affect the settings and safeties of the operating system of the robot control system 100. For instance, safety settings of the robot control system 100 override the safety settings of any one of the plugin containers 120A-C.

Therefore, the container environment 120 could have numerous plugin containers, such as 120A-C. If required or desired, the plugin containers 120A-C may all be active at the same time—though a single one, two or more could be active at the same time as well. Moreover, the plugin containers 120A-C may be independent from one another. The containers 120A-C may each be a separate application that runs in an isolated space, but with the containers 120A-C using the same operating system OS of the robot control system 100. For example, one of the plugin containers 120A-C may be provided to control the gripper or other end effector, another one of the plugin containers 120A-C may be used to operator a vision system, another one of the plugin containers 120A-C may be tied to an application or contemplated use of the robot (e.g.: palletizing, bin picking, etc), another one of the plugin containers 120A-C may be for PLC communication, etc. The plugin containers 120A-C, may therefore operate concurrently as functions performed by the plugin containers 120A-C may be complementary, such as container for the gripper and another for the vision system. In addition, some plugin containers 120A-C may be active passively. For example, a plugin container 120A-C may be in a supervisory role, or handling non-realtime communication, or triggered only at a certain moment, whereas some may be timed/in-sync with the real-time robot control system 100 or in sync with an external trigger.

In an embodiment, the container environment 120 is configured for cloud communication. Therefore, one or more of the containers 120A-C may collaborate with cloud-based systems to enhance their functionalities. For example, a container 120A-C may collaborate with a cloud-based system or available processor or server to have access to higher computing power. The higher computing power may allow a container 120A-C to benefit from complex algorithms and/or to feed data to and from and receive commands from artificial intelligence systems.

In an embodiment, the container environment 120 may allow the use of peripherals 50, such as add-on peripherals and extension, and replacement of control system hardware, such as GPU 102B and interfaces 102D, as a function of the containers 120A-C. As an example, the robot control system 100 is configured to facilitate the removal and upgrade of the GPU 102B, for instance to enable first-class (integrated) GPU-acceleration support, in order to facilitate improvements in computing power over time. The container environment 120 may dynamically benchmark and adjusts or throttle the available performance of each container application in line with available acceleration of the CPU and/or GPU 102B.

In terms of added functionalities, the container environment may support common AI frameworks, to enable functions such as for image/part detection, segmentation, localization directly in a visual programming tool, with the image or video feed from a camera of the peripherals 50 (i.e., part of a vision system).

The robot control system 100 can be described as including a processing unit, such as the CPU 102A; and a non-transitory computer-readable memory 102C communicatively coupled to the processing unit and comprising computer-readable program instructions executable by the processing unit for: operating movements of a robot arm with an operating system using native functions of the robot arm; executing a program from at least one container; receiving commands from the at least one container; and performing at least a function with the robot arm with the operating system using commands from the at least one container.

In a variant, the robot control system 100 may be described as being a robot control system having a processing unit; and a non-transitory computer-readable memory communicatively coupled to the processing unit and comprising computer-readable program instructions executable by the processing unit for operating: an operating system controlling movements of a robot arm; native functions of the robot arm; and at least one container commanding additional functions of the robot arm via a container-specific operating system. While the expression “container-specific operating system”, this may be regarded as the binaries, libraries and/or runtime enabling execution of a functionality or functionalities of a container, via the shared operating system of the robot control system 100, shared by more than one containers in a variant. The operating system may be a shared host for numerous containers.

The robot control system 100 may alternatively or additionally be described as including a processing unit like the CPU 102A; and a non-transitory computer-readable memory 102C communicatively coupled to the processing unit and comprising computer-readable program instructions executable by the processing unit for operating: an operating system controlling movements of a robot arm; native functions of the robot arm; and at least one container commanding additional functions of the robot arm.

The container environment 120 may result in an improvement of the security and safety in the operation of the robot arm 10, by isolating the plugin containers 120A-C from the native functions 110 and core operations of the robot control system 100, with the dependencies of the containers 120A-C being isolated. The container environment 120 may also provide more freedom in terms of programming language and resource management for the containers 120A-C. Program updates and nodes may be managed at the container level as well. The container environment 120 may allow shorter lead time to implement robot applications while reducing risks of faulty operation. For third party container developers, this may result in lower project risks, more precise predictability of implementation costs and time, and access to a robust and independent operating system of the robot control system 100. The container environment 120 may be for software plugins, though it may enable the use of supplemental hardware peripherals dedicated to the plugin containers if not present in the existing peripherals 50.

By way of examples, tables are provided to describe some plugin containers 120 that may be used with the robot arm 10, with different types of tools used as peripherals 50. However, the containers of the container environment 120 are not necessarily tied to peripherals 50. For example, a container could be present to allow the robot control system 100 to access applications in the cloud, etc.

In a first example, the plugin container 120 is to provide 3D vision, such as supported by artificial intelligence, with a 3D vision sensor being the peripheral 50. The table lists native functions, with additional functions that may be performed by the operating system of the robot control system 100, and the plugin container functions:

### Native Functions

3D Vision Feed
AI GPU Support
Control: Advanced Path Planning
Control: Feature Frames and
Transfer/Offsets
Control: Waypoints
Internal Gigabit Ethernet
GigE Vision Compliant Cameras Support
Global Custom References
Kortex API
Logging/Data Recorder
Plugin General Infrastructure
Plug-in HMI Editor
Plugin License Management
Robot Simulator
Safety Functions

### Additional Functions

Plugin: Landmark
Plugin: 3D matching

### Plugin Functions

Vision: 3rd party 3D vision sensor
Vision: 3rd party 3D vision AI model library

In a second example and a third example, the plugin container 120 is to provide finger gripper control, or vacuum end effector, i.e., used as peripherals 50. The table lists native functions, with additional functions that may be performed by the operating system of the robot control system 100, and the plugin container functions:

### Native Functions

Wrist Buttons and IOs
Wrist Industrial Communications Protocols
Tool Manager: Tool Plugin Specialization
Control: Feature Frames and Transfer/Offsets
Control: Protection zones (3D)
Control: Self-collision detection
Plugin General Infrastructure

### Additional Functions

Plugin: Modbus Master (Integrated to Visual
Programming)
Plugin: RS485 Master

### Plugin Functions

Finger gripper control
Vacuum end effector control

In a fourth example, the plugin container 120 is to provide a machine tending application, such as a CNC as peripheral 50. The table lists native functions, with additional functions that may be performed by the operating system of the robot control system 100, and the plugin container functions:

### Native Functions

2D Vision Feed
Base: Safety IOs as General IOs
Wrist Force-torque sensor
Visual Programming
Variable Manager
Tool Manager: Tool Plugin Specialization
Control: Collision Sensing
Control: Feature Frames and Transfer/Offsets
Control: Force Control Mode & Tuning
Control: Joint Impedance & Hand Guiding
Control: Protection zones (3D)
Control: Self-collision detection
Control: Waypoints
Internal Gigabit Ethernet
IO Support
Multi-thread visual programming
Plugin General Infrastructure
Plug-in HMI Editor
Program Script (offline programming)
Safety Functions
Singularity Management

### Additional Functions

Plugin: Matrix Action
Plugin: Dual Gripper Support
Plugin: Industrial IO
Plugin: Industrial—Modbus Master (for Plugin Developers)
Plugin: Conveyor Tracking
Plugin: Modbus Master (Integrated to Visual Programming)
Plugin: RS485 Master

### Plugin Functions

Plugin: 3rd Party 2-finger gripper
Plugin: CNC control

In a fifth example, the plugin container 120 is to provide a screwdriving application, with the screwdriver being the peripheral 50. The table lists native functions, with additional functions that may be performed by the operating system of the robot control system 100, and the plugin container functions:

### Native Functions

1 kHz Control
Wrist Force-torque sensor
Visual Programming
Variable Manager
Tool Manager: Tool Plugin Specialization
Control: CAD-based path planning
Control: Collision Sensing
Control: Feature Frames and Transfer/Offsets
Control: Force Control Mode & Tuning
Control: Protection zones (3D)
Control: Self-collision detection
Control: Waypoints
Internal Gigabit Ethernet
IO Support
Kortex API
Plugin General Infrastructure
Plug-in HMI Editor
Program Script (offline programming)
Safety Functions
Singularity Management

### Additional Functions

Plugin: Matrix Action
Plugin: Force Based Insertion
Plugin: Industrial—Modbus Master (for Plugin
Developers)
Plugin: RS485 Master

### Plugin Functions

Plugin: 3rd Party Automatic Screwdriver

In a sixth example, the plugin container 120 is to provide a dispensing application. The table lists native functions, with additional functions that may be performed by the operating system of the robot control system 100, and the plugin container functions:

### Native Functions

1 kHz Control
Control: Advanced Path Planning
Visual Programming
Variable Manager
Tool Manager: Tool Plugin Specialization
Control: CAD-based path planning
Control: Collision Sensing
Control: Feature Frames and Transfer/Offsets
Control: Joint Impedance & Hand Guiding
Control: Locked Axes
Control: Self-collision detection
Control: Waypoints
Internal Gigabit Ethernet
IO Support
Kortex API
Plugin General Infrastructure
Plug-in HMI Editor
Program Script (offline programming)
Safety Functions
Singularity Management

### Additional Functions

Plugin: Industrial IO
Plugin: Industrial—Modbus Master (for Plugin Developers)
Plugin: RS485 Master

### Plugin Functions

Plugin: 3rd party dispenser (IO control)

1. A system comprising:
a processing unit; and
a non-transitory computer-readable memory communicatively coupled to the processing unit and comprising computer-readable program instructions executable by the processing unit for:
operating movements of a robot arm with an operating system using native functions of the robot arm;
executing a program from at least one container;
receiving commands from the at least one container; and
performing at least a function with the robot arm with the operating system using the commands from the at least one container.

2. The system according to claim 1, wherein the computer-readable program instructions are executable for operating movements of the robot arm in six degrees of freedom of movement.

3. The system according to claim 1, wherein the computer-readable program instructions are executable for receiving and storing the at least one container.

4. The system according to claim 1, wherein the computer-readable program instructions are executable for receiving and storing the at least one container as a third-party container.

5. The system according to claim 1, wherein the computer-readable program instructions are executable for executing the program from a plurality of at least one container concurrently.

6. The system according to claim 5, wherein the computer-readable program instructions are executable for controlling the execution of the programs of the plurality of containers as a function of performance capacity of the operating system.

7. The system according to claim 1, wherein the computer-readable program instructions are executable for receiving the commands from the at least one container as associated with a tool and/or a peripheral.

8. The system according to claim 7 wherein the computer-readable program instructions are executable for performing at least the function with the robot arm and with the tool and/or peripheral.

9. The system according to claim 8, wherein the computer-readable program instructions are executable for performing at least the function with the robot arm and with the tool and/or peripheral, the function including a combination of the native functions and at least one function of the tool and/or peripheral.

10. (canceled)

11. (canceled)

12. The system according to claim 1, wherein the computer-readable program instructions are executable for receiving commands from the at least one container, the commands being received from cloud computing and/or an artificial intelligence network.

13. The system according to claim 1, wherein the computer-readable program instructions are executable for performing at least a function with the robot arm with the operating system using the commands from the at least one container while limiting the function to native function capability of the robot arm.

14. (canceled)

15. (canceled)

16. A robot system comprising:
a robot arm;
a robot controller system including a processing unit; and a non-transitory computer-readable memory communicatively coupled to the processing unit and comprising computer-readable program instructions executable by the processing unit for operating:
an operating system performing native functions of the robot arm, and
a container environment for at least one container,
wherein the at least one container is executable to send commands from the at least one container, and
wherein the robot arm performs at least a function using the commands from the at least one container.

17. The robot system according to claim 16, wherein the robot arm is a serial mechanism having a working end displaceable in at least six degrees of freedom of movement.

18. (canceled)

19. The system according to claim 16, wherein the computer-readable program instructions are executable for executing the program from a plurality of at least one container concurrently.

20. The robot system according to claim 19, wherein the computer-readable program instructions are executable for controlling the execution of the programs of the plurality of containers as a function of performance capacity of the operating system.

21. The robot system according to claim 16, wherein the computer-readable program instructions are executable for receiving the commands from the at least one container as associated with a tool and/or a peripheral.

22. The robot system according to claim 21 wherein the computer-readable program instructions are executable for performing at least the function with the robot arm and with the tool and/or peripheral.

23. (canceled)

24. The robot system according to claim 21, including the tool and/or peripheral.

25. (canceled)

26. The robot system according to claim 16, wherein the computer-readable program instructions are executable for receiving commands from the at least one container, the commands being received from cloud computing and/or an artificial intelligence network.

27. The robot system according to claim 16, wherein the computer-readable program instructions are executable for performing at least a function with the robot arm with the operating system using the commands from the at least one container while limiting the function to native function capability of the robot arm.

28. (canceled)
